(19) United States
(12) Patent Application Publication
(10) Pub. No.: US 2024/0144300 A1
(43) Pub. Date: May 2, 2024

(54) CHARACTERISTIC INFORMATION GENERATING APPARATUS, SYSTEM, METHOD, AND COMPUTER-READABLE MEDIUM

(71) Applicant: NEC Corporation, Minato-ku, Tokyo (JP)

(72) Inventors: Shintaro CHIKU, Tokyo (JP); Yuki TSUJI, Tokyo (JP); Naoko FUKUSHI, Tokyo (JP); Yoko TANAKA, Tokyo (JP); Kazuki OGATA, Tokyo (JP); Kosei KOBAYASHI, Tokyo (JP); Kei YANAGISAWA, Tokyo (JP)

(73) Assignee: NEC Corporation, Minato-ku, Tokyo (JP)

(21) Appl. No.: 18/279,145

(22) PCT Filed: Mar. 4, 2021
(86) PCT No.: PCT/JP2021/008408

§ 371 Date: Aug. 28, 2023

(51) Int. Cl. G06Q 30/0201

(52) U.S. Cl. CPC G06Q 30/0201

(57) ABSTRACT

Estimating means estimates first characteristic information pertaining to persons present within an area for which an estimation is made, based on first information obtained by tallying signals transmitted from terminal devices of users in the area for which the estimation is made and second information which is statistical information of the area for which the estimation is made. Based on the second characteristic information generated by an analyzing apparatus that analyzes an image, verifying means verifies the first characteristic information estimated by the estimating means. Based on the verification result of the verifying means, correcting means corrects the estimation of the first characteristic information estimated by the estimating means.

### TECHNICAL FIELD

The present disclosure relates to characteristic information generating apparatuses, systems, methods, and computer-readable media.

### BACKGROUND ART

As related art, Patent Literature 1 discloses a population estimating apparatus that estimates a population with use of information pertaining to communication between user devices and base stations. The population estimating apparatus described in Patent Literature 1 acquires control log information of communication between base stations and mobile stations (user devices). A control log includes a connection start time at which a mobile station has started connecting to a base station and a connection end time at which the mobile station had ended the connection to the base station. With use of acquired control log information, the population estimating apparatus estimates the number of mobile stations present within a cell formed by a base station.

For example, according to Patent Literature 1, a base station communicates with mobile stations of users having a contract with the communication service provider that operates the base station. Therefore, an estimated number of mobile stations represents the number of mobile stations of users having a contract with a certain communication service provider. According to Patent Literature 1, the population estimating apparatus can acquire the share percentage of a communication service provider for mobile stations and, with use of an acquired share percentage, correct an estimated result of the number of mobile stations. For example, the population estimating apparatus multiplies the estimated number of mobile stations by the reciprocal of a share percentage and thus extrapolates the total number of mobile stations including users having a contract with other communication service providers. With use of the estimated result of the total number of mobile stations, the population estimating apparatus estimates the population of each area. Patent Literature 2 is a literature describing another related art.

As yet another related art, Patent Literature 3 discloses a crowd monitoring device that estimates the degree of congestion or a flow of a crowd. The crowd monitoring device described in Patent Literature 3 receives sensor data from a sensor, such as a camera, installed in an area to be monitored. Based on received sensor data, the crowd monitoring device derives a state parameter indicating a state feature value of a crowd detected by a camera. A derived state parameter includes “crowd density,” “moving direction and speed of crowd,” “flow rate,” “extraction result of specific person,” and “extraction result of person of specific category.”

### CITATION LIST

### Patent Literature

Patent Literature 1: Japanese Unexamined Patent Application Publication No. 2020-155799
Patent Literature 2: Japanese Unexamined Patent Application Publication No. 2013-73290
Patent Literature 3: Japanese Patent No. 6261815

### SUMMARY OF INVENTION

### Technical Problem

According to Patent Literature 1 or 2, statistical information, such as the number of users carrying a terminal device (mobile terminal), can be tallied in each area. However, not everyone carries a mobile terminal. Techniques according to Patent Literature 1 or 2 cannot collect information from a person not carrying a mobile terminal. Although Patent Literature 1 describes a technique for extrapolating a population with use of, for example, a share percentage, there is no assurance as to how accurate an extrapolated population is.

According to Patent Literature 3, since the crowd density (degree of congestion) and so forth are estimated with use of a camera, this technique can count people not carrying a mobile terminal as well. The accuracy of estimating the number of people with use of a camera is conceivably higher than the accuracy of estimating the number of people based on wireless communication. However, an imaging range of a camera is generally smaller than a wireless communication range. Therefore, if the number of people is to be tallied in a wide range, cameras need to be installed at a large number of spots. The cost necessary for installing and maintaining cameras is higher than such cost for wireless communication apparatuses, and it is not realistic to install cameras at a large number of spots.

The present disclosure is directed to providing a characteristic information generating apparatus, system, method, and computer-readable medium that can solve at least a part of the problem described above.

### Solution to Problem

To achieve the object above, the present disclosure provides, as a first aspect, a characteristic information generating apparatus. The characteristic information providing apparatus includes: estimating means configured to estimate first characteristic information pertaining to persons present within an area for which an estimation is made, based on first information obtained by tallying signals transmitted from a terminal device of a user in the area and second information which is statistical information pertaining to a number of persons in the area; verifying means configured to verify the estimated first characteristic information based on second characteristic information pertaining to persons present within an imaging range of an image captured by an imaging device installed in the area, the second characteristic information being obtained by analyzing the image; and correcting means configured to correct the estimation of the first characteristic information estimated by the estimating means, based on a verification result of the verifying means.

The present disclosure provides, as a second aspect, a characteristic information generating system. The characteristic information providing system includes: a tallying apparatus configured to tally signals transmitted from a terminal device of a user in an area for which an estimation is made and generate first information; a characteristic information generating apparatus configured to generate first characteristic information pertaining to persons present in the area using the first information; and an analyzing apparatus configured to analyze an image captured by an imaging device installed in the area and generate second characteristic information pertaining to persons present within an imaging range of the image. The characteristic information generating apparatus includes: estimating means configured to estimate the first characteristic information based on the first information and second information which is statistical information pertaining to a number of persons in the area, verifying means configured to verify the estimated first characteristic information based on the second characteristic information, and correcting means configured to correct the estimation of the first characteristic information estimated by the estimating means, based on a verification result of the verifying means.

The present disclosure provides, as a third aspect, a characteristic information generating method. The characteristic information generating method includes: estimating first characteristic information pertaining to persons present within an area for which an estimation is made, based on first information obtained by tallying signals transmitted from a terminal device of a user in the area and second information which is statistical information pertaining to a number of persons in the area; verifying the estimated first characteristic information based on second characteristic information pertaining to persons present within an imaging range of an image captured by an imaging device installed in the area, the second characteristic information being obtained by analyzing the image; and correcting the estimation of the first characteristic information based on a verification result of the first characteristic information.

The present disclosure provides, as a fourth aspect, a computer-readable medium. The computer-readable medium stores a program that causes a computer to perform the processes of: estimating first characteristic information pertaining to persons present within an area for which an estimation is made, based on first information obtained by tallying signals transmitted from a terminal device of a user in the area and second information which is statistical information pertaining to a number of persons in the area; verifying the estimated first characteristic information based on second characteristic information pertaining to persons present within an imaging range of an image captured by an imaging device installed in the area, the second characteristic information being obtained by analyzing the image; and correcting the estimation of the first characteristic information based on a verification result of the first characteristic information.

### Advantageous Effects of Invention

The characteristic information generating apparatus, system, method, and computer-readable medium according to the present disclosure can solve at a part of the problem described above.

### BRIEF DESCRIPTION OF DRAWINGS

FIG. 1 is a block diagram schematically showing a characteristic information generating system according to the present disclosure.

FIG. 2 is a block diagram showing a schematic configuration of a characteristic information generating apparatus.

FIG. 3 is a block diagram showing a characteristic information generating system according to one example embodiment of the present disclosure.

FIG. 4 shows a specific example of first information.

FIG. 5 is a block diagram showing an example of a configuration of a characteristic information generating apparatus.

FIG. 6 shows a plurality of areas for which an estimation is made and an area in which an imaging device is installed.

FIG. 7 is a flowchart showing procedures of an operation of a characteristic information generating apparatus.

FIG. 8 is a block diagram showing an example of a configuration of a computer apparatus.

### EXAMPLE EMBODIMENT

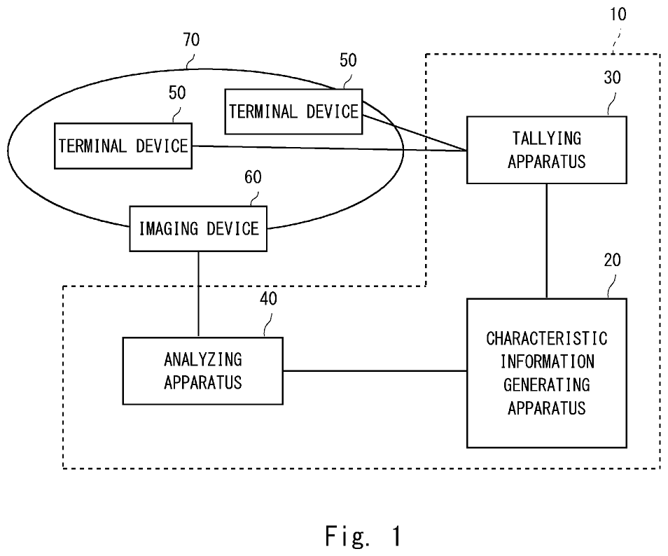

Prior to the description of some example embodiments of the present disclosure, an outline of the present disclosure will be given. FIG. 1 schematically shows a characteristic information generating system according to the present disclosure. A characteristic information generating system 10 includes a characteristic information generating apparatus 20, a tallying apparatus 30, and an analyzing apparatus 40. The tallying apparatus 30 tallies signals transmitted from terminal devices 50 of users in an area 70 for which an estimation is made and generates first information. With use of the first information, the characteristic information generating apparatus 20 generates first characteristic information pertaining to persons present within the area for which the estimation is made. The analyzing apparatus 40 analyzes an image captured by an imaging device 60 installed within the area 70 for which tallying is performed and generates second characteristic information pertaining to persons present within the imaging range of the image.

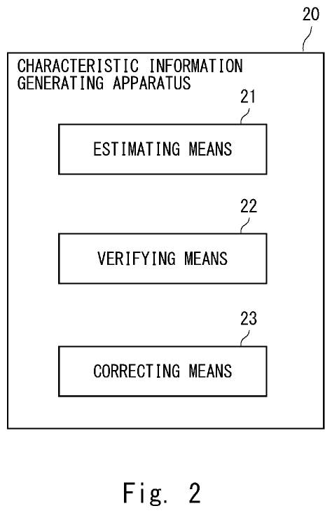

FIG. 2 shows a schematic configuration of a characteristic information generating apparatus. The characteristic information generating apparatus 20 includes an estimating means 21, a verifying means 22, and a correcting means 23. Based on the first information described above and second information which is statistical information pertaining to the number of persons in the area 70 for which the estimation is made, the estimating means 21 estimates the first characteristic information pertaining to the persons present within the area 70 for which the estimation is made. Based on the second characteristic information generated by the analyzing apparatus 40, the verifying means 22 verifies the first characteristic information estimated by the estimating means 21. Based on a verification result of the verifying means 22, the correcting means 23 corrects the estimation of the first characteristic information estimated by the estimating means 21.

According to the present disclosure, the verifying means 22 verifies first characteristic information based on the first characteristic information generated with use of first information that the tallying apparatus 30 generates and second characteristic information that the analyzing apparatus 40 generates through an image analysis. The correcting means 23 corrects the estimation of the first characteristic information based on a verification result of the verifying means 22. In the characteristic information generating system 10, although the tallying apparatus 30 can conceivably acquire, from terminal devices 50, information concerning a range greater than the imaging range of the imaging device 60, the tallying apparatus 30 can only tally information of users carrying a terminal device 50. In contrast, since the analyzing apparatus 40 generates second characteristic information through an image analysis, this makes it possible to acquire information of users not carrying a terminal device 50 as well. However, the imaging range of an image is conceivably smaller than a range in which the tallying apparatus 30 can receive signals from terminal devices 50. According to the present disclosure, first characteristic information estimated areally is verified with use of second characteristic information obtained through a pinpoint analysis, and the first characteristic information is corrected accordingly. With this configuration, the present disclosure makes it possible to estimate characteristic information pertaining to the number of persons with high accuracy while using information received from users' terminal devices.

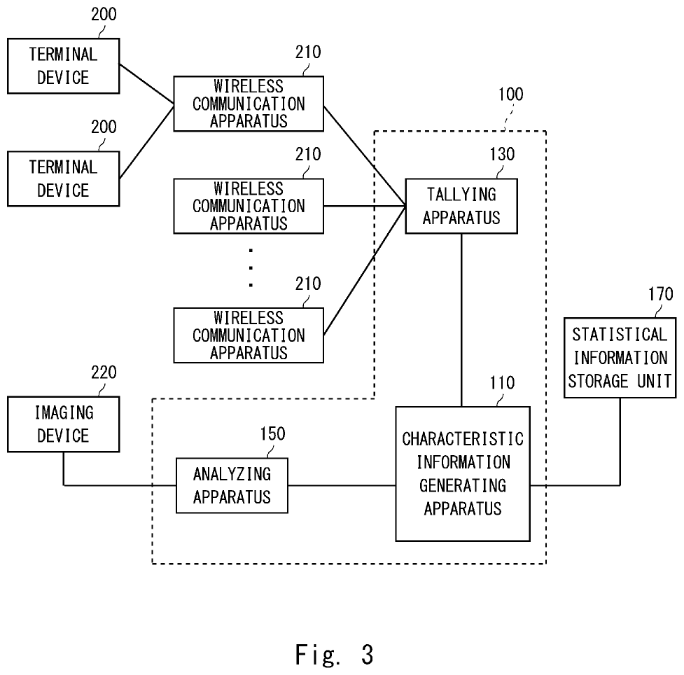

Some example embodiments of the present disclosure will be described below in detail. FIG. 3 shows a characteristic information generating system according to one example embodiment of the present disclosure. A characteristic information generating system 100 includes a characteristic information generating apparatus 110, a tallying apparatus 130, and an analyzing apparatus 150. In the characteristic information generating system 100, the characteristic information generating apparatus 110, the tallying apparatus 130, and the analyzing apparatus 150 are configured, for example, as computer apparatuses, such as a server apparatus or a personal computer (PC). The characteristic information generating apparatus 110, the tallying apparatus 130, and the analyzing apparatus 150 need not necessarily be configured as physically separate apparatuses. The characteristic information generating system 100 corresponds to the characteristic information generating system 10 shown in FIG. 1.

The tallying apparatus 130 is connected to a plurality of wireless communication apparatuses 210. Each wireless communication apparatus 210 receives a signal from one or more terminal devices 200 within a wirelessly communicable range. For example, each terminal device 200 is configured as a Wi-Fi (registered trademark)-equipped device. To search for a Wi-Fi access point, each terminal device 200 periodically outputs probe information (probe signal). A wireless communication apparatus 210 receives probe information output from a terminal device 200 present within a wirelessly communicable range. Probe information includes, for example, information, such as a media access control (MAC) address, for identifying a terminal device 200.

A terminal device 200 may have installed therein an application for transmitting information to a wireless communication apparatus 210. A user can register, in the application, attribute information, such as age, nationality, or gender. A terminal device 200 (application) may transmit, to a wireless communication apparatus 210, information for identifying the terminal device 200, its position information, and a user's attribute information. Registration of attribute information is optional. If no attribute information is registered, a terminal device 200 may transmit, to a wireless communication apparatus 210, information for identifying the terminal device 200 and its position information. A terminal device 200 corresponds to a terminal device 50 shown in FIG. 1.

The tallying apparatus 130 tallies signals transmitted from terminal devices 200 in an area for which an estimation is made and generates first information (tally result). First information indicates, for example, the number of terminal devices 200 present within an area for which the estimation is made. To rephrase, first information indicates the number of users carrying a terminal device 200 in an area for which the estimation is made.

The tallying apparatus 130 generates first information of each of a plurality of areas for which the estimation is made. The tallying apparatus 130 generates first information, for example, of each of a plurality of areas for which the estimation is made that are obtained by partitioning a specific geographical range in a mesh-like pattern by a predetermined distance. The tallying apparatus 130 may, for example, generate first information for each attribute, such as age, nationality, or gender. The tallying apparatus 130 may divide a length of time into a plurality of time ranges and generate first information for each time range. The tallying apparatus 130 corresponds to the tallying apparatus 30 shown in FIG. 1.

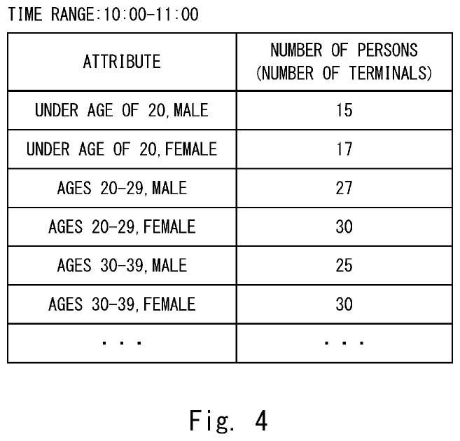

FIG. 4 shows a specific example of first information. In this example, the tallying apparatus 130 tallies, by gender and age, the number of terminal devices (the number of persons) present in an area within a certain time range. For example, as shown in FIG. 4, a tally result obtained indicates that, in 1 hour from 10:00 to 11:00, the number of males under the age of 20 is 15. Another tally result obtained indicates that, in the same time range, the number of females under the age of 20 is 17. The tallying apparatus 130 tallies the number of persons for each attribute for other time ranges as well. If no attribute information of a user is transmitted from a terminal device 200, that user may be classified as attribute unknown. The tallying apparatus 130 outputs generated first information to the characteristic information generating apparatus 110 (see FIG. 3).

Referring back to FIG. 3, the analyzing apparatus 150 acquires an image from an imaging device 220. The imaging device 220 is installed in a specific area for which the estimation is made. The imaging device 220 is disposed, for example, at a spot representative of an area for which the estimation is made. The imaging device 220 is installed, for example, on a main street, at an entrance to a commercial establishment, or at an entrance or exit of a transportation facility, such as a station. The imaging device 220 may be installed, for example, on a traffic signal, a streetlight, or a utility pole. The imaging device 220 captures an image of an object, such as a person, moving within its imaging range. The imaging device 220 corresponds to the imaging device 60 shown in FIG. 1.

The analyzing apparatus 150 performs an image analyzing process on an image acquired from the imaging device 220 and generates characteristic information pertaining to persons present within the imaging range of the image. Characteristic information that the analyzing apparatus 150 generates includes, for example, the number of persons present within an imaging range that are counted for each attribute, such as age, nationality, or gender. The analyzing apparatus 150 may divide a length of time into a plurality of time ranges and generate characteristic information for each time range. The analyzing apparatus 150 outputs generated characteristic information to the characteristic information generating apparatus 110. The analyzing apparatus 150 corresponds to the analyzing apparatus 40 shown in FIG. 1.

Although FIG. 3 shows only one imaging device 220, the number of imaging devices 220 is not limited to one. The analyzing apparatus 150 may acquire an image from each of a plurality of imaging devices 220. According to the present example embodiment, the number of imaging devices 220 may be smaller than the number of areas for which the estimation is made. To rephrase, an imaging device 220 may be installed in one or more of a plurality of areas for which the estimation is made.

A statistical information storage unit 170 stores statistical information pertaining to the number of persons present within an area for which the estimation is made. The statistical information storage unit 170 may be configured as, for example, a database that stores statistical information. Statistical information includes information that makes it possible to identify the number of persons of each attribute present in an area for which the estimation is made. For example, statistical information includes information indicating the number of persons of each attribute present in each of a plurality of areas for which the estimation is made. Alternatively, statistical information includes the number of persons present in each of a plurality of areas for which the estimation is made and information indicating a composition ratio of attributes in each area. Statistical information may include information that makes it possible to identify the number of persons of each attribute who are present in an area for which the estimation is made in each time range. The statistical information storage unit 170 may store a plurality of pieces of statistical information regarding each area for which the estimation is made.

The statistical information described above may be, for example, information from a national census. Alternatively, the statistical information described above may be information showing an actual record of use of a commercial establishment or the like. Information showing an actual record of use may be, for example, point of sales (POS) data acquired from a POS terminal installed at a store, such as a convenience store. Statistical information may include an actual record of a turnout of people in a city, the traffic volume of vehicles and people, or an actual record of the number of people going through a ticket gate. Statistical information may include second characteristic information generated by the analyzing apparatus 150.

The characteristic information generating apparatus 110 acquires first information from the tallying apparatus 130 and acquires statistical information (second information) from the statistical information storage unit 170. Furthermore, the characteristic information generating apparatus 110 acquires, from the analyzing apparatus 150, characteristic information (second characteristic information) generated by the analyzing apparatus 150. With use of the first information and the second information, the characteristic information generating apparatus 110 estimates characteristic information (first characteristic information) pertaining to persons present within an area for which the estimation is made. Based on the estimated first characteristic information and the second characteristic information acquired from the analyzing apparatus 150, the characteristic information generating apparatus 110 verifies the first characteristic information. Based on a verification result of the first characteristic information, the characteristic information generating apparatus 110 corrects the estimation of the first characteristic information. The characteristic information generating apparatus 110 corresponds to the characteristic information generating apparatus 20 shown in FIG. 1.

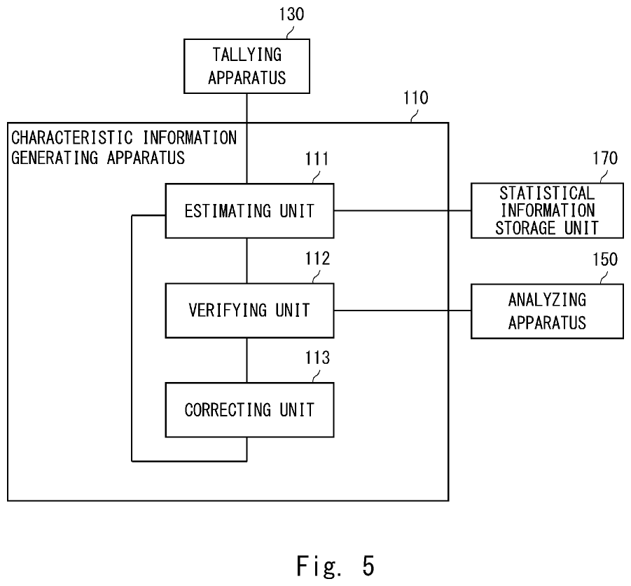

FIG. 5 shows an example of a configuration of the characteristic information generating apparatus 110. The characteristic information generating apparatus 110 includes an estimating unit 111, a verifying unit 112, and a correcting unit 113. The estimating unit 111 acquires first information from the tallying apparatus 130. Furthermore, the estimating unit 111 acquires statistical information from the statistical information storage unit 170. Based on the first information and the statistical information, the estimating unit 111 extrapolates first characteristic information pertaining to persons present within an area for which the estimation is made. If the statistical information storage unit 170 stores a plurality of pieces of statistical information, the estimating unit 111 may estimate first characteristic information with use of statistical information selected from among the plurality of pieces of statistical information.

Based on first information generated of each of a plurality of areas for which the estimation is made and statistical information of each of the plurality of areas for which the estimation is made, for example, the estimating unit 111 estimates first information of each area. The estimating unit 111 estimates first characteristic information of, for example, each of a plurality of areas for which the estimation is made that are partitioned in a mesh-like pattern. The estimating unit 111 may estimate first characteristic information for each attribute of persons. Alternatively, the estimating unit 111 may estimate first characteristic information for each time range and for each attribute. The estimating unit 111 corresponds to the estimating means 21 shown in FIG. 2.

The verifying unit 112 acquires estimated first characteristic information from the estimating unit 111. Furthermore, the verifying unit 112 acquires characteristic information (second characteristic information) obtained through an image analysis from the analyzing apparatus 150. The verifying unit 112 compares the first characteristic information and the second characteristic information and verifies the estimated first characteristic information. At this point, the verifying unit 112 verifies first characteristic information of, among a plurality of areas for which the estimation is made, an area in which the imaging device 220 (see FIG. 3) is installed, based on the first characteristic information and second characteristic information of the area in which the imaging device 220 is installed.

The verifying unit 112 verifies, for example, whether first characteristic information and second characteristic information are disparate. With use of the area of an area for which the estimation is made, for example, the verifying unit 112 converts first characteristic information into information that indicates the number of persons per unit area, that is, into information that indicates a density. Furthermore, with use of the area of an imaging range of an imaging device, the verifying unit 112 converts second characteristic information into information that indicates a density. The verifying unit 112 may compare the first characteristic information converted to density information and the second characteristic information converted to density information and verify whether the first characteristic information and the second characteristic information are disparate. The verifying unit 112 corresponds to the verifying means 22 shown in FIG. 2.

Based on a verification result of the verifying unit 112, the correcting unit 113 corrects the estimation of first characteristic information estimated by the estimating unit 111. Based on a verification result of the verifying unit 112, the correcting unit 113 corrects the estimation of first characteristic information of each of a plurality of areas for which the estimation is made including an area in which the imaging device 220 is installed and an area in which no imaging device 220 is installed. The correcting unit 113 may correct first characteristic information estimated by the estimating unit 111, with use of a verification result of the verifying unit 112. Alternatively or additionally, the correcting unit 113 may correct the estimation of first characteristic information by selecting statistical information to be used in the estimating unit 111 based on a verification result.

First characteristic information estimated by the estimating unit 111 is generated with use of information that a wireless communication apparatus 210 receives from a terminal device 200. For example, if information that a terminal device 200 transmits includes a user's attribute information, information regarding attributes in estimated first characteristic information is conceivably accurate. However, not everyone carries a terminal device 200, and there may be a user who carries a plurality of terminal devices 200. Therefore, the accuracy of the number of persons in first characteristic information can be somewhat low.

In contrast, second characteristic information generated by the analyzing apparatus 150 is generated through an analysis of an image captured by the imaging device 220. Therefore, the accuracy of the number of persons in second characteristic information is conceivably higher. However, since the analyzing apparatus 150 estimates, for example, the gender or age of each person based on an image analysis, as compared to a case in which attribute information received from a terminal device 200 is used, the accuracy of information regarding attributes in second characteristic information is conceivably lower. It is conceivable that, when the verifying unit 112 verifies first characteristic information with use of the first characteristic information and second characteristic information and when the correcting unit 113 corrects the estimation of the first characteristic information based on a verification result, the characteristics of the two pieces of characteristic information can complement each other.

If first characteristic information and second characteristic information are disparate, for example, the correcting unit 113 corrects the estimation of the first characteristic information estimated by the estimating unit 111 so as to reduce the disparity. The correcting unit 113 corrects the estimation of the first characteristic information, for example, such that the ratio of attributes in the first characteristic information approaches the ratio of attributes in the second characteristic information. Alternatively, the correcting unit 113 may correct the estimation of the first characteristic information with use of the ratio of the number of persons of each attribute in the first characteristic information and the number of persons of each attribute in the second characteristic information. The correcting unit 113 may correct the estimation of the first characteristic information by replacing the first characteristic information with the second characteristic information.

In addition to the corrections described above, the correcting unit 113 may correct the estimation of the first characteristic information with use of the ratio of the area of the area for which the first characteristic information is estimated and the area of the range of the image analysis by the analyzing apparatus 150. Furthermore, the correcting unit 113 may correct the estimation of the first characteristic information with use of the ratio of the number of streets, the number of sidewalks, or the width of streets or sidewalks in the area for which the first characteristic information is estimated and the number of streets, the number of sidewalks, or the width of streets or sidewalks in the range of the image analysis.

If a communicable range of a wireless communication apparatus 210 includes a place that people pass, such as a passage, and a facility, such as a restaurant, first characteristic information includes information regarding people passing a passage or the like and information regarding people staying at a facility. Meanwhile, the imaging device 220 is typically installed to capture an image of a place that people pass, and second characteristic information conceivably includes a large amount of information regarding people passing by. In addition to the corrections described above, the correcting unit 113 may acquire the usage rate or the like of a facility within an area for which first characteristic information is estimated and correct the estimation of the first characteristic information with use of the acquired usage rate. The correcting unit 113 may, for example, estimate the number of persons passing by and the number of persons staying at a facility based on the acquired usage rate and correct the first characteristic information with respect to each number.

The estimating unit 111 outputs estimated first characteristic information to an external apparatus (not illustrated). The estimating unit 111, for example, outputs the real value indicating the number of persons for each attribute in each area as first characteristic information. Alternatively, the estimating unit 111 outputs level information indicating the level of congestion for each attribute in each area as first characteristic information. As an alternative to the above, the estimating unit 111 may display estimated first characteristic information on a display apparatus (not illustrated). The correcting unit 113 corresponds to the correcting means 23 shown in FIG. 2.

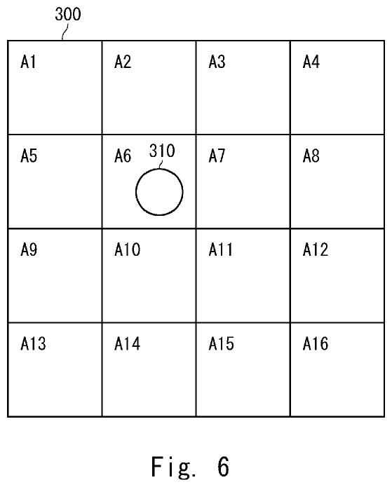

FIG. 6 shows a plurality of areas for which the estimation is made and an area in which the imaging device 220 is installed. In the example shown in FIG. 6, areas for which the estimation is made include 16 areas 300 (A1 to A16) partitioned in a mesh-like pattern. Each area 300 includes a wirelessly communicable range of a wireless communication apparatus 210 (see FIG. 3). The wirelessly communicable range of each wireless communication apparatus 210 need not necessarily match an area 300. In the example shown in FIG. 6, the imaging device 220 is installed in the area A6. The imaging device 220 captures an image of within an imaging range 310 covering a part of the area A6.

Regarding each of the areas A1 to A16, the tallying apparatus 130 tallies signals transmitted from terminal devices 200 and generates first information. Regarding each of the areas A1 to A16, the estimating unit 111 of the characteristic information generating apparatus 110 estimates first characteristic information with use of the first information tallied by the tallying apparatus 130 and statistical information of each area. Based on an image captured by the imaging device 220, the analyzing apparatus 150 analyzes characteristics of persons present within the imaging range 310 in the area A6 and generates second characteristic information.

The verifying unit 112 compares the first characteristic information estimated for the area A6 and the second characteristic information obtained through an analysis of the imaging range in the area A6 and thus verifies the first characteristic information. With use of a verification result of the first characteristic information of the area A6, the correcting unit 113 corrects the first characteristic information of the area A6. Furthermore, the correcting unit 113 applies, to the other areas A1 to A5 and A7 to A16, a correction similar to the correction applied to the first characteristic information of the area A6 and corrects first characteristic information estimated for each area.

In this example, it can be said that the correction of the estimation of the first characteristic information of the area A6 in which the imaging device 220 is installed corresponds to the expansion of an analysis result (second characteristic information) of the imaging range 310 onto the area A6 with use of a comparison result (difference) between the first characteristic information and the second characteristic information of the area A6. Furthermore, it can be said that the correction of the estimation of the first characteristic information of the areas A1 to A5 and A7 to A16 corresponds to the propagation of a comparison result between the first characteristic information and the second characteristic information of the area A6 to the areas A1 to A5 and A7 to A16. Therefore, it can be said that the correction that the correcting unit 113 performs on the estimation of first characteristic information of each area corresponds to the extrapolation of an analysis result of the imaging range 310 with use of a verification result of the verifying unit 112 and first information of each area generated by the tallying apparatus 130.

In the example described above, the imaging range 310 is set within one area for which the estimation is made, but the present example embodiment is not limited to this example. The imaging range 310 may be set over a plurality of areas for which the estimation is made. In this case, the verifying unit 112 may verify the mean of a plurality of pieces of first characteristic information of the respective areas for which the estimation is made with use of second characteristic information. The number of imaging devices 220 is not limited to one, and a plurality of imaging devices 220 may be installed in a plurality of areas for which the estimation is made. If a plurality of imaging devices 220 are used and second characteristic information is obtained of a plurality of areas for which the estimation is made, the correcting unit 113 may correct first characteristic information of each area with use of the mean of verification results of the plurality of areas.

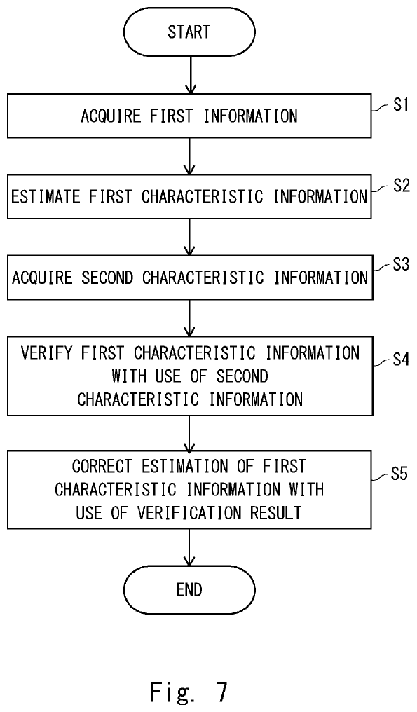

Next, procedures of an operation will be described. FIG. 7 shows procedures of an operation (characteristic information generating method) of the characteristic information generating apparatus 110. The estimating unit 111 acquires, from the tallying apparatus 130, first information generated as the tallying apparatus 130 tallies signals transmitted from terminal devices 200 (step SD. The estimating unit 111 acquires statistical information from the statistical information storage unit 170 and estimates first characteristic information based on the first characteristic information and the second information acquired at step S1 (step S2).

The verifying unit 112 acquires, from the analyzing apparatus 150, second characteristic information generated as the analyzing apparatus 150 analyzes an image captured by the imaging device 220 (step S3). Based on the first characteristic information estimated at step S2 and the second characteristic information acquired at step S3, the verifying unit 112 verifies the first characteristic information estimated at step S2 (step S4). The correcting unit 113 corrects the estimation of the first characteristic information estimated by the estimating unit 111 (step S5). The estimating unit 111 outputs the estimated first characteristic information to, for example, an external apparatus.

According to the present example embodiment, the tallying apparatus 130 can conceivably acquire information from terminal devices 200 in a range greater than the imaging range of the imaging device 220. However, the tallying apparatus 130 can tally only information of a user carrying a terminal device 200. In contrast, since the analyzing apparatus 150 generates second characteristic information through an image analysis, this makes it possible to acquire information of a user not carrying a terminal device 200 as well. Yet, the imaging range of an image is conceivably smaller than the range in which the tallying apparatus 130 can receive a signal from a terminal device 200. According to the present example embodiment, the verifying unit 112 verifies first characteristic information based on the first characteristic information and second characteristic information. The correcting unit 113 corrects the first characteristic information with use of a verification result. According to the present example embodiment, the characteristic information generating apparatus 110 can correct first characteristic information estimated areally, with use of second characteristic information obtained through a pinpoint analysis. Therefore, the present example embodiment makes it possible to estimate first characteristic information with high accuracy while using information received from terminal devices 200.

According to the present example embodiment, the verifying unit 112 verifies first characteristic information of an area for which the estimation is made and for which both the first characteristic information and second characteristic information are generated. To rephrase, the verifying unit 112 verifies first characteristic information of an area for which the estimation is made and in which the imaging device 220 is installed. With use of a verification result of the verifying unit 112, the correcting unit 113 corrects the first characteristic information of a plurality of areas for which the estimation is made including areas in which no imaging device 220 is installed. According to the present example embodiment, the characteristic information generating apparatus 110 estimates the estimation of first characteristic information of a plurality of areas for which the estimation is made, with use of second characteristic information generated with use of the imaging device 220 installed in a part of the plurality of areas for which the estimation is made. With this configuration, the characteristic information generating apparatus 110 can generate highly accurate first characteristic information while preventing a cost increase as compared to a case in which an imaging device 220 is installed in each area for which the estimation is made.

In the example described according to the foregoing example embodiment, the characteristic information generating apparatus 110 and the tallying apparatus 130 are separate from each other. The present disclosure, however, is not limited to this example. Instead of acquiring first information which is a tally result from the tallying apparatus 130, the characteristic information generating apparatus 110 may acquire data on signals that have been transmitted from terminal device 200 but have not been tallied. In this case, the characteristic information generating apparatus 110 may include a tallying apparatus (tallying means) that tallies signals transmitted from terminal devices 200 and generates first information.

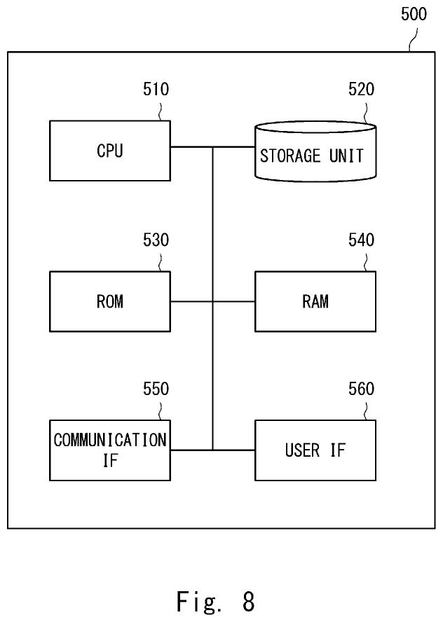

In the present disclosure, the characteristic information generating apparatus 110, the tallying apparatus 130, and the analyzing apparatus 150 may be configured as computer apparatuses (server apparatuses). FIG. 8 shows an example of a configuration of a computer apparatus that may be used, for example, as a characteristic information generating apparatus. A computer apparatus 500 includes a control unit (CPU: central processing unit) 510, a storage unit 520, a read-only memory (ROM) 530, a random-access memory (RAM) 540, a communication interface (IF) 550, and a user interface 560.

The communication interface 550 is an interface for connecting the computer apparatus 500 to a communication network via a wired communication means or a wireless communication means. The user interface 560 is a display unit, such as a display. The user interface 560 includes an input unit, such as a keyboard, a mouse, or a touch panel.

The storage unit 520 is an auxiliary storage device that can hold various pieces of data. The storage unit 520 need not be a part of the computer apparatus 500 and may be an external storage device or a cloud storage connected to the computer apparatus 500 via a network. The storage unit 520 may be used as the statistical information storage unit 170 (see FIG. 3).

The ROM 530 is a nonvolatile storage device. For the ROM 530, a relatively small-capacity semiconductor storage device, such as a flash memory, is used. A program that the CPU 510 executes can be stored in the storage unit 520 or the ROM 530. The storage unit 520 or the ROM 530 stores various programs for implementing functions of each unit of, for example, the characteristic information generating apparatus 110.

Such programs can be stored with use of various types of non-transitory computer-readable media and supplied to the computer apparatus 500. Non-transitory computer-readable media include various types of tangible storage media. Examples of non-transitory computer-readable media include a magnetic recording medium, a magneto-optical recording medium, an optical disc medium, and a semiconductor memory. A magnetic recording medium includes, for example, a recording medium such as a flexible disk, a magnetic tape, or a hard disk. A magneto-optical recording medium includes, for example, a recording medium such as a magneto-optical disk. An optical disc medium includes a disc medium such as a compact disc (CD) or a digital versatile disc (DVD). A semiconductor memory includes a memory such as a mask ROM, a programmable ROM (PROM), an erasable PROM (EPROM), a flash ROM, or a RAM. A program may be supplied to a computer with use of various types of transitory computer-readable media. Examples of such transitory computer-readable media include an electric signal, an optical signal, and an electromagnetic wave. A transitory computer-readable medium can supply a program to a computer via a wired communication line, such as an electric wire or an optical fiber, or via a wireless communication line.

The RAM 540 is a volatile storage device. For the RAM 540, any of various semiconductor memory devices, such as a dynamic random-access memory (DRAM) or a static random-access memory (SRAM), is used. The RAM 540 may be used as an internal buffer that temporarily stores data and so forth. The CPU 510 loads a program stored in the storage unit 520 or the ROM 530 onto the RAM 540 and executes the program. As the CPU 510 executes the program, functions of each unit of the characteristic information generating apparatus 110 may be implemented. The CPU 510 may include an internal buffer that can temporarily store data and so forth.

Thus far, some example embodiments of the present disclosure have been described in detail, but the foregoing example embodiments do limit the present disclosure. An example embodiment obtained by making a change or modification to the foregoing example embodiments within a range that does not depart from the scope and spirit of the present disclosure may also be encompassed by the present disclosure.

For example, part or the whole of the foregoing example embodiments may also be described as in the following supplementary notes, and these are not limiting.

### [Supplementary Note 1]

A characteristic information generating apparatus including:
estimating means configured to estimate first characteristic information pertaining to persons present within an area for which an estimation is made, based on first information obtained by tallying signals transmitted from a terminal device of a user in the area and second information which is statistical information pertaining to a number of persons in the area;
verifying means configured to verify the estimated first characteristic information based on second characteristic information pertaining to persons present within an imaging range of an image captured by an imaging device installed in the area, the second characteristic information being obtained by analyzing the image; and
correcting means configured to correct the estimation of the first characteristic information estimated by the estimating means, based on a verification result of the verifying means.

### [Supplementary Note 2]

The characteristic information generating apparatus according to supplementary note 1, wherein
the estimating means is configured to estimate the first characteristic information for a plurality of areas for which an estimation is made, and
the verifying means is configured to verify the first characteristic information estimated for, among the plurality of areas for which an estimation is made, an area in which the imaging device is installed, based on the first characteristic information and second characteristic information estimated for the area in which the imaging device is installed.

### [Supplementary Note 3]

The characteristic information generating apparatus according to supplementary note 2, wherein the correcting means is configured to correct, for the plurality of areas for which the estimation is made, the estimation of the first characteristic information based on the verification result of the verifying means.

### [Supplementary Note 4]

The characteristic information generating apparatus according to supplementary note 2 or 3, wherein the estimating means is configured to estimate the first characteristic information for a plurality of areas for which the estimation is made that are partitioned in a mesh-like pattern.

### [Supplementary Note 5]

The characteristic information generating apparatus according to any one of supplementary notes 1 to 4, wherein
the second information includes information capable of identifying a number of persons present within the area for each attribute, and
the estimating means is configured to estimate the first characteristic information for each attribute.

### [Supplementary Note 6]

The characteristic information generating apparatus according to any one of supplementary notes 1 to 4, wherein
the second information includes information capable of identifying a number of persons present within the area in each time range for each attribute, and
the estimating means is configured to estimate the first characteristic information for each attribute and for each time range.

### [Supplementary Note 7]

The characteristic information generating apparatus according to any one of supplementary notes 1 to 6, wherein the first information indicates a number of persons present in the area and carrying the terminal device.

### [Supplementary Note 8]

The characteristic information generating apparatus according to any one of supplementary notes 1 to 7, wherein the correcting means is configured to correct the estimated first characteristic information using the verification result of the verifying means.

### [Supplementary Note 9]

The characteristic information generating apparatus according to any one of supplementary notes 1 to 8, wherein
the estimating means is configured to use, as the second information, statistical information selected from among a plurality of pieces of statistical information pertaining to persons in the area, and
the correcting means is configured to correct the estimation of the first characteristic information by selecting statistical information used as the second information by the estimating means, based on the verification result of the verifying means.

### [Supplementary Note 10]

The characteristic information generating apparatus according to any one of supplementary notes 1 to 9, further including tallying means configured to collect signals transmitted from the terminal device of the user and generate the first information by tallying the signals collected in the area.

### [Supplementary Note 11]

A characteristic information generating system including:
a tallying apparatus configured to tally signals transmitted from a terminal device of a user in an area for which an estimation is made and generate first information;
a characteristic information generating apparatus configured to generate first characteristic information pertaining to persons present in the area using the first information; and
an analyzing apparatus configured to analyze an image captured by an imaging device installed in the area and generate second characteristic information pertaining to persons present within an imaging range of the image,
wherein the characteristic information generating apparatus includes
estimating means configured to estimate the first characteristic information based on the first information and second information which is statistical information pertaining to a number of persons in the area,
verifying means configured to verify the estimated first characteristic information based on the second characteristic information, and
correcting means configured to correct the estimation of the first characteristic information estimated by the estimating means, based on a verification result of the verifying means.

### [Supplementary Note 12]

The characteristic information generating system according to supplementary note 11, wherein
the tallying apparatus is configured to generate the first information for each of a plurality of areas for which the estimation is made,
the estimating means is configured to estimate the first characteristic information for the plurality of areas for which the estimation is made, and
the verifying means is configured to verify the first characteristic information estimated for, among the plurality of areas for which the estimation is made, an area in which the imaging device is installed, based on the first characteristic information and second characteristic information estimated for the area in which the imaging device is installed.

### [Supplementary Note 13]

The characteristic information generating system according to supplementary note 12, wherein the correcting means is configured to correct, for the plurality of areas for which estimation is made, the estimation of the first characteristic information based on the verification result of the verifying means.

### [Supplementary Note 14]

The characteristic information generating system according to supplementary note 12 or 13, wherein the estimating means is configured to estimate the first characteristic information for a plurality of areas for which the estimation is made that are partitioned in a mesh-like pattern.

### [Supplementary Note 15]

The characteristic information generating system according to any one of supplementary notes 11 to 14, further including a wireless communication apparatus installed in the area and configured to receive the signal transmitted from the terminal device.

### [Supplementary Note 16]

A characteristic information generating method including:
estimating first characteristic information pertaining to persons present within an area for which an estimation is made, based on first information obtained by tallying signals transmitted from a terminal device of a user in the area and second information which is statistical information pertaining to a number of persons in the area;
verifying the estimated first characteristic information based on second characteristic information pertaining to persons present within an imaging range of an image captured by an imaging device installed in the area, the second characteristic information being obtained by analyzing the image; and
correcting the estimation of the first characteristic information based on a verification result of the first characteristic information.

### [Supplementary Note 17]

A non-transitory computer-readable medium storing a program that causes a computer to perform the processes of:
estimating first characteristic information pertaining to persons present within an area for which an estimation is made, based on first information obtained by tallying signals transmitted from a terminal device of a user in the area and second information which is statistical information pertaining to a number of persons in the area;
verifying the estimated first characteristic information based on second characteristic information pertaining to persons present within an imaging range of an image captured by an imaging device installed in the area, the second characteristic information being obtained by analyzing the image; and
correcting the estimation of the first characteristic information based on a verification result of the first characteristic information.

### REFERENCE SIGNS LIST

10: CHARACTERISTIC INFORMATION GENERATING SYSTEM
20: CHARACTERISTIC INFORMATION GENERATING APPARATUS
21: ESTIMATING MEANS
22: VERIFYING MEANS
23: CORRECTING MEANS
30: TALLYING APPARATUS
40: ANALYZING APPARATUS
50: TERMINAL DEVICE
60: IMAGING DEVICE
70: AREA
100: CHARACTERISTIC INFORMATION GENERATING SYSTEM
110: CHARACTERISTIC INFORMATION GENERATING APPARATUS
111: ESTIMATING UNIT
112: VERIFYING UNIT
113: CORRECTING UNIT
130: TALLYING APPARATUS
150: ANALYZING APPARATUS
200: TERMINAL DEVICE
210: WIRELESS COMMUNICATION APPARATUS
220: IMAGING DEVICE
300: AREA
310: IMAGING RANGE

What is claimed is:

1. A characteristic information generating apparatus comprising:
a first memory storing first instructions; and
a first processor configured to execute the first instructions to:
perform an estimation of first characteristic information pertaining to persons present within an area for which an estimation is made, based on first information obtained by tallying signals transmitted from a terminal device of a user in the area and second information which is statistical information pertaining to a number of persons in the area;
perform verification of the estimated first characteristic information based on second characteristic information pertaining to persons present within an imaging range of an image captured by an imaging device installed in the area, the second characteristic information being obtained by analyzing the image; and
correct the estimation of the first characteristic information, based on a result of the verification.

2. The characteristic information generating apparatus according to claim 1, wherein the first processor is configured to execute the first instructions to:
perform the estimation of the first characteristic information for a plurality of areas for which an estimation is made, and
perform the verification of the first characteristic information estimated for, among the plurality of areas for which an estimation is made, an area in which the imaging device is installed, based on the first characteristic information and second characteristic information estimated for the area in which the imaging device is installed.

3. The characteristic information generating apparatus according to claim 2, wherein the first processor is configured to execute the first instructions to correct, for the plurality of areas for which the estimation is made, the estimation of the first characteristic information based on the result of the verification.

4. The characteristic information generating apparatus according to claim 2, wherein the first processor is configured to execute the first instructions to perform the estimation of the first characteristic information for a plurality of areas for which the estimation is made that are partitioned in a mesh-like pattern.

5. The characteristic information generating apparatus according to claim 1, wherein
the second information includes information for identifying a number of persons present within the area for each attribute, and
the first processor is configured to execute the first instructions to perform the estimation of the first characteristic information for each attribute.

6. The characteristic information generating apparatus according to claim 1, wherein
the second information includes information for identifying a number of persons present within the area in each time range for each attribute, and
the first processor is configured to execute the first instructions to perform the estimation of the first characteristic information for each attribute and for each time range.

7. The characteristic information generating apparatus according to claim 1, wherein the first information indicates a number of persons present in the area and carrying the terminal device.

8. The characteristic information generating apparatus according to claim 1, wherein the first processor is configured to execute the first instructions to correct the estimated first characteristic information using the result of the verification.

9. The characteristic information generating apparatus according to claim 1, wherein
the first processor is configured to execute the first instructions to:
when performing the estimation of the first characteristic information, use, as the second information, statistical information selected from among a plurality of pieces of statistical information pertaining to persons in the area, and
correct the estimation of the first characteristic information by selecting statistical information used as the second information, based on the result of the verification.

10. The characteristic information generating apparatus according to claim 1, wherein the first processor is further configured to execute the first instructions to collect signals transmitted from the terminal device of the user and generate the first information by tallying the signals collected in the area.

11. A characteristic information generating system comprising:
the characteristic information generating apparatus according to claim 1;
a tallying apparatus comprising a second memory storing second instructions and a second processor configured to execute the second instructions to tally signals transmitted from a terminal device of a user in an area for which an estimation is made and generate the first information; and
an analyzing apparatus comprising a third memory storing third instructions and a third processor configured to execute the third instruction to analyze an image captured by an imaging device installed in the area and generate the second characteristic information pertaining to persons present within an imaging range of the image.

12. The characteristic information generating system according to claim 11, wherein
the second processor is configured to execute the second instructions to generate the first information for each of a plurality of areas for which the estimation is made,
the first processor is configured to execute the first instructions to perform the estimation of the first characteristic information for the plurality of areas for which the estimation is made, and
the first processor is configured to execute the first instructions to verify the first characteristic information estimated for, among the plurality of areas for which the estimation is made, an area in which the imaging device is installed, based on the first characteristic information and second characteristic information estimated for the area in which the imaging device is installed.

13. The characteristic information generating system according to claim 12, wherein the first processor is configured to execute the first instructions to correct, for the plurality of areas for which estimation is made, the estimation of the first characteristic information based on the result of the verification.

14. The characteristic information generating system according to claim 12, wherein the first processor is configured to execute the first instructions to perform the estimation of the first characteristic information for a plurality of areas for which the estimation is made that are partitioned in a mesh-like pattern.

15. The characteristic information generating system according to claim 11, further comprising a wireless communication apparatus installed in the area and configured to receive the signal transmitted from the terminal device.

16. A characteristic information generating method comprising:
estimating first characteristic information pertaining to persons present within an area for which an estimation is made, based on first information obtained by tallying signals transmitted from a terminal device of a user in the area and second information which is statistical information pertaining to a number of persons in the area;
verifying the estimated first characteristic information based on second characteristic information pertaining to persons present within an imaging range of an image captured by an imaging device installed in the area, the second characteristic information being obtained by analyzing the image; and
correcting the estimation of the first characteristic information based on a verification result of the first characteristic information.

17. A non-transitory computer-readable medium storing a program that causes a computer to perform the processes of:
estimating first characteristic information pertaining to persons present within an area for which an estimation is made, based on first information obtained by tallying signals transmitted from a terminal device of a user in the area and second information which is statistical information pertaining to a number of persons in the area;
verifying the estimated first characteristic information based on second characteristic information pertaining to persons present within an imaging range of an image captured by an imaging device installed in the area, the second characteristic information being obtained by analyzing the image; and
correcting the estimation of the first characteristic information based on a verification result of the first characteristic information.
